(19) United States
(12) Patent Application Publication
(10) Pub. No.: US 2004/0231337 A1
(43) Pub. Date: Nov. 25, 2004

(54) Gas turbine

(76) Inventor: Peter Jakadofsky, Vienna (AT)

Correspondence Address: LADAS & PARRY LLP, 224 SOUTH MICHIGAN AVENUE, SUITE 1200, CHICAGO, IL, 60604, US

(21) Appl. No.: 10/484,340

(22) PCT Filed: Jul. 16, 2002
(86) PCT No.: PCT/AT02/00209

(30) Foreign Application Priority Data
Jul. 24, 2001 (AT) A 1150/2001

(51) Int. Cl. F02C 1/00

(52) U.S. Cl. 60/793; 60/726

(57) ABSTRACT

A gas turbine (1), in particular for model aircraft, model helicopters and other small propulsion units, comprising a drive shaft (3) rotatably mounted by means of two main bearings (13, 13′) and extending through an annular combustion chamber (2) and to which a compressor impeller (4) and a turbine wheel (11) are non-rotationally connected, and a driven shaft (14) driven by said drive shaft (3), wherein a device comprised of front toothed wheels is provided for transmitting the torque from the drive shaft (3) to the driven shaft (14) between the two main bearings (13, 13′).

The invention relates to a gas turbine, in particular for model aircraft, model helicopters and other small propulsion units, comprising a drive shaft rotatably mounted by means of two main bearings and extending through an annular combustion chamber and to which a compressor impeller and a turbine wheel are non-rotationally connected, and a driven shaft driven by said drive shaft. Besides being used as propulsion unit for model aircraft for the purpose of which they usually are provided with a propeller wheel on the driven side, and as a propulsion unit for model helicopters, for the purpose of which they are usually provided with a centrifugal clutch with a toothed wheel or a toothed pulley on the driven side, such gas turbines are also used for other small drives, such as generators and water pumps, as well as for military applications for which they are particularly suitable because of the low noise and, above all, space-saving drive.

Usually, in such gas turbines, a planetary gear is arranged at the front side, i.e. at the compressor side, of the gas turbine for reducing the rotational speed of the drive shaft, and via this planetary gear a connection to the drive shaft can be established. Such gas turbines are, however, complex and have relatively large dimensions. Moreover, on account of the end-side torque output at the drive shaft, there results an additional force of excitation for the drive shaft which may result in an unstable oscillating behavior of the drive shaft. For this reason, it is often necessary to provide an additional supporting bearing.

As the closest prior art, known gas turbines according to the initially indicated preamble can be mentioned, wherein torque output is upstream of the compressor impeller via a planetary drive, such gas turbines being, e.g., the Artouste model of the company Turbomeca, France.

U.S. Pat. No. 2,955,657 A as well as U.S. Pat. No. 2,711,295 A each describe gas turbines having cylindrical combustion chambers which are radially arranged about a central drive shaft. From the drive shaft, the torque is received by means of bevel wheels, deflected and used for driving one or two rotors, respectively.

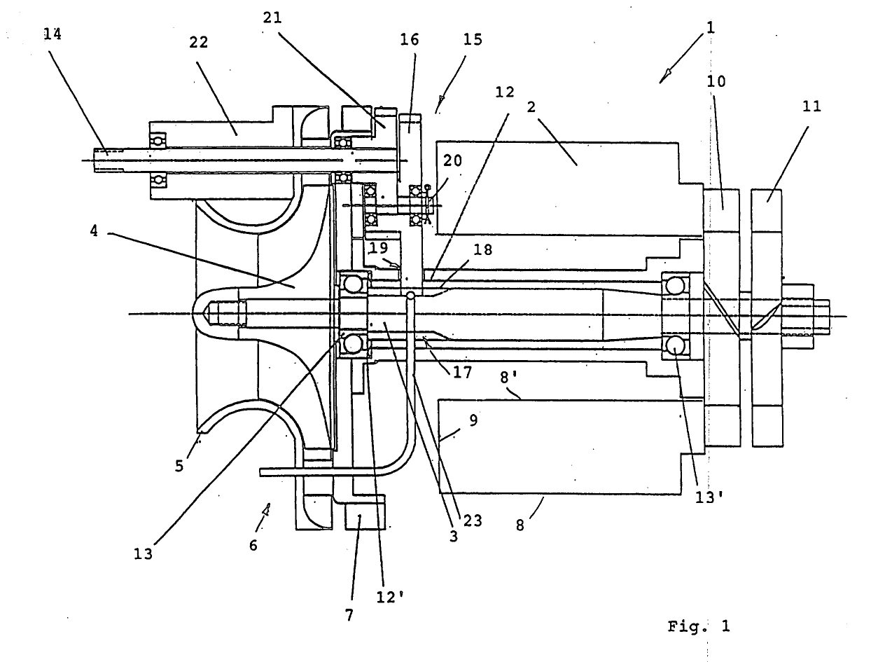

DE 11 23 522, in turn, relates to a propeller turbine jet engine, wherein according to FIG. 1, a two-shaft turbine is shown with a combustion chamber arranged to follow the drive shaft, in which toothed wheels for receiving a torque are arranged on the idle running device.

It is now an object of the invention to provide a gas turbine of the initially defined type, in which the torque transmission from the drive shaft to the driven shaft is effected in as simple a manner as possible. In addition, the drive shaft shall exhibit a stable oscillating behavior so that it will not be necessary to provide additional bearing sites. Moreover, the gas turbine shall have smaller dimensions and a lower total weight compared to known devices.

The gas turbine according to the invention of the initially defined type is characterized in that a device comprised of front toothed wheels is provided for transmitting the torque from the drive shaft to the driven shaft between the two main bearings. By receiving the torque and transmitting it to the driven shaft between the two main bearings, there results a drive unit which has a relatively small extension in the axial direction of the drive shaft and, moreover, the oscillating behavior of the drive shaft is only slightly altered. Thus, no additional supporting bearings need be provided, resulting in turn in a production which is simple in terms of construction and cost-effective.

In particular, the excitations as regards bending oscillations of the drive shaft are kept low if the device for transmitting the torque is provided adjacent one of the two main bearings. For reasons of construction, in particular for transmitting the torque to a driven shaft with a propeller wheel, it is advantageous if the device for torque transmission is provided adjacent the forward main bearing. In doing so, it is also advantageous if the device for transmitting the torque is provided in a gap between a forward guiding system and the combustion chamber. Thus, the dead space required for structural reasons between the forward guiding system and the combustion chamber can be utilized in a meaningful way, wherein the gap between the forward guiding system and the combustion chamber is required for a reliable entry of air into the combustion chamber, since thus air can enter both via the forward front side and also via the inner side whereby, in turn, an efficient combustion is attained.

If a toothed gearing is provided as said device for torque transmission, a structurally simple transmission of the rotational speed from the drive shaft to the driven shaft is feasible and, by choosing the steps of the toothed gearing at will, the desired reduction of the rotational speed of the driven shaft relative to the rotational speed of the drive shaft can be achieved. In most applications of the gas turbine according to the invention it is particularly suitable if a two-step toothed gearing is provided, since this results in a low number of parts and, thus, in a simple construction, on the one hand, while the desired reduction can be achieved by means of the two-step gear in an efficient manner, on the other hand. In addition, in a two-step gear there results a distance of the driven shaft from the drive shaft by which it becomes possible to receive the output of the driven shaft in a simple manner by means of a propeller wheel, e.g.

As regards a particularly simple, efficient mounting of the gas turbine according to the invention it is advantageous if the drive shaft, at least in portions thereof, has a milled-in toothing, since thus, the drive shaft with its rear main bearing, a rearward guiding system and the turbine wheel can be inserted into the combustion chamber or into a shaft tunnel provided therein, respectively. As regards a simple mounting of the drive shaft, it is also suitable if the toothing is provided on the end portion of the drive shaft facing the forward guiding system, since thus, the drive shaft can be inserted from the rear side when the toothed gearing has already been installed.

As regards a reliable bearing of the drive shaft and a simple reception of the shaft output, it is suitable if a toothed wheel of the toothed gearing is in connection with the toothing of the drive shaft via a recess in a jacket-shaped shaft tunnel surrounding the drive shaft.

To obtain a rotational speed suitable for the driven shaft, it is advantageous if a reduction of the rotational speed of the drive shaft to the rotational speed of the driven shaft from 6-10:1, preferably from 8:1, is provided, wherein the drive shaft can rotate with up to approximately 120 000 rpm.

To allow for an unimpeded further transmission of the torque from the driven shaft, it is advantageous if the driven shaft projects forwardly to beyond the compressor impeller. When using the gas turbine as a propulsion unit for model aircraft it is particularly suitable if a propeller wheel is non-rotationally connected to the driven shaft. In the propulsion of model helicopters, on the other hand, it is advantageous if the driven shaft is connected to a toothed wheel or to a toothed pulley via a centrifugal clutch.

If a lubricating duct ends in the region of the toothing of the drive shaft, lubricant can reliably be introduced via the lubricating duct into the region of the toothing between the drive shaft and the first toothed wheel of the toothed gearing provided for torque transmission.

Here it is particularly advantageous if a fuel/oil mixture is provided for lubrication. If the torque transmission is effected in the vicinity of the forward main bearing, advantageously the spray mist resulting during the lubrication will be entrained by the pressure difference between the compressor stage and the turbine stage in the direction of the rearward main bearing in the shaft tunnel, additionally resulting in the advantageous effect of the bearing being cooled.

As regards the oscillating properties of the drive shaft, tests have shown that it is particularly advantageous if the drive shaft has an external diameter of from 13 to 15 mm, with a steel shaft preferably being used. The bearings used with such a drive shaft as a rule have a diameter of approximately 22 mm at the most.

In the following, the invention will be explained in more detail by way of a preferred exemplary embodiment illustrated in the drawing to which, however, it shall not be restricted.

In detail, the drawing shows a longitudinal section of the gas turbine.

In FIG. 1, a gas turbine 1 can be seen with an annular combustion chamber 2, which is passed through by a drive shaft 3. On the inlet side, a compressor impeller 4 is provided which, together with the compressor cover 5, forms the compressor stage 6. Subsequently, the air compressed in the compressor stage 6 is guided via a forward guiding system 7 in the direction towards the combustion chamber 2, wherein the entry of air occurs both via openings in the jacket face 8 of the combustion chamber and via the front side 9 and the inner side 8′.

After it has emerged from the combustion chamber 2, the combustion gas is supplied to the turbine wheel 11 via a rearward guiding system 10, which turbine wheel is non-rotationally connected to the drive shaft 3. The turbine wheel preferably is made in one piece by machining as disclosed in the Austrian Utility Model AT 2429 U.

The drive shaft 3 is rotatably mounted in a shaft tunnel 12 by means of the forward spindle ball bearing 13 and a rearward spindle ball bearing 13′, the forward spindle ball bearing 13 being received with a shaft spring 12′ in the shaft tunnel 12 so as to increase the bearing tension.

To transmit the shaft output of the drive shaft 3 to a driven shaft 14, a toothed gearing 15 is provided. For an engagement of an intermediate toothed wheel 16 on the drive shaft 3, the drive shaft 3 has a portion 17 in which a toothing 18 has been milled in. In the usual applications of such a gas turbine, e.g. as a propulsion unit for model aircraft or for smaller stationary drives, such as generators, water pumps or also for military applications, the drive shaft has a rotational speed of up to 120 000 rpm, and in the two-stage reduction via the toothing 17 of the drive shaft 3, the intermediate wheel 16 and the driven toothed wheel 31 there occurs a rotational speed reduction of approximately 6-10:1.

Since the toothing 18 has been milled into the drive shaft 3, the drive shaft 3 including the rearward spindle ball bearing 13′, the rearward guiding system 10 and the turbine wheel 11 can be inserted in the shaft tunnel 12 when the gas turbine 1 is mounted. Common dimensions are approximately 13 to 15 mm of the shaft diameter, and a maximum of 22 mm for the bearing diameter.

For engagement of the toothed wheel 16 with the toothing 18 of the drive shaft 3, the shaft tunnel 12 has a recess 19. The intermediate toothed wheel 16 which is rotatably mounted via a shaft 20, has a stepped diameter for reducing the rotational speed of the drive shaft 3, wherein a toothed wheel 21 on the driven side which is non-rotationally connected to the driven shaft 14 engages with the toothing of the smaller diameter.

The driven shaft 14 is arranged in a bearing pedestal 22 in parallel to the drive shaft 3 and laterally spaced from the drive shaft 3 so that, when the gas turbine 1 is used for a turbo-propeller propulsion unit, a propeller wheel (not illustrated) can be attached at the forward end of the driven shaft 14 which forwardly projects beyond the compressor stage 6.

To lubricate the toothed gearing 15, a lubricating duct 23 is provided in the region where the toothed wheel 16 engages in the toothing 18 of the drive shaft 3, via which a kerosene/oil mixture is introduced into the region of the meshing connection. By the pressure difference between the compressor stage 6 and the turbine wheel 11, the kerosene/oil mixture that is atomized by the toothed wheels 16 and by the toothing 17, respectively, is sucked towards the rear spindle ball bearing 13′, advantageously resulting in a cooling of the spindle bearing.

From the meshing engagement of the intermediate toothed wheel 16 for the transmission of torque from the drive shaft 3 to the driven shaft 14 between the two spindle ball bearings 13, 13′ immediately adjacent the forward spindle ball bearing 13, there result especially stable conditions, in particular as regards the oscillating behavior of the drive shaft 3.

Thus, it is not necessary to provide a planetary drive at the forward end of the drive shaft 3 for reducing the rotational speed of the drive shaft 3 to a driven shaft 14. Thus, a shorter construction length and also a lower overall weight of the arrangement is attained in comparison to known gas turbines. Moreover, additional supporting bearings are not required.

Moreover, due to the laterally spaced arrangement of the driven shaft 14 from the drive shaft 3, the complete initial cross-section of the compressor stage 6 is maintained, and also an electric starter can be attached to the compressor impeller 4 without any problems.

1. A gas turbine in particular for model aircraft, model helicopters and other small propulsion units, comprising a drive shaft rotatably mounted by means of two main bearings and extending through an annular combustion chamber and to which a compressor impeller and a turbine wheel are non-rotationally connected, and a driven shaft driven by said drive shaft, wherein a device comprised of front toothed wheels is provided for transmitting the torque from the drive shaft to the driven shaft between the two main bearings, wherein the device for torque transmission is provided in a gap between a forward guiding system and the combustion chamber.

2. A gas turbine according to claim 1, wherein the device for torque transmission is provided adjacent one of the two main bearings.

3. A gas turbine according to claim 2, wherein the device for torque transmission is provided adjacent the forward main

4. A gas turbine according to claim 1, wherein a two-step toothed gearing is provided as device for torque transmission.

5. A gas turbine according to claim 1, wherein the drive shaft at least in portions thereof comprises a milled-in toothing.

6. A gas turbine according to claim 5, wherein the toothing is provided on that end portion of the drive shaft which faces the forward guiding system.

7. A gas turbine according to claim 1, wherein a toothed wheel of the toothed gearing is in connection with the toothing of the drive shaft via a recess in a jacket-shaped shaft tunnel surrounding the drive shaft.

8. A gas turbine according to claim 1, wherein a reduction of the rotational speed of the drive shaft to the rotational speed of the driven shaft of 6-10:1, preferably of 8:1, is provided.

9. A gas turbine according to claim 1, wherein the driven shaft forwardly projects beyond the compressor impeller.

10. A gas turbine according to claim 9, wherein a propeller wheel is non-rotationally connected to the driven shaft.

11. A gas turbine according to claim 9, wherein the driven shaft is connected to a toothed wheel or to a toothed pulley by means of a centrifugal clutch.

12. A gas turbine according to claim 5, wherein a lubricant duct ends in the region of the toothing of the drive shaft.

13. A gas turbine according to claim 12, wherein a fuel/oil mixture is provided for lubrication purposes.

14. A gas turbine according to claim 1, wherein the drive shaft has an external diameter of from 13 to 15 mm.
